(19) United States
(12) Patent Application Publication
(10) Pub. No.: US 2014/0067480 A1
(43) Pub. Date: Mar. 6, 2014

(54) SYSTEMS AND METHODS FOR ENTERPRISE-LEVEL CONTEXT MANAGEMENT

(71) Applicant: James R. Carter, Acworth, GA (US)

(72) Inventor: James R. Carter, Acworth, GA (US)

(73) Assignee: Rocket Software, Inc.

(21) Appl. No.: 13/604,224

(22) Filed: Sep. 5, 2012

(51) Int. Cl. G06Q 10/00

(52) U.S. Cl. 705/7.36

(57) ABSTRACT

A new approach is proposed that contemplates systems and methods to facilitate enterprise-level context management, which is a construct used to manage access and changes to business entities at the enterprise level instead of application level, where the business entities are used by many legacy applications and the underlying data is stored across multiple systems of record of data. An enterprise context manager is a software layer that secures exclusive access to a collection of related, yet disparate applications and resources ahead of a coordinated multiphase commit. The enterprise context manager provides a complete view of a business entity by presenting various aspects of data of the business entity through a single, unified user interface. It commits changes made to the data managed by two or more legacy applications together or rolls the data back to a pre-commit status if all changes cannot be applied.

### BACKGROUND

Legacy applications are typically standalone applications deployed and operating within an enterprise and provide various kinds of services to users. Legacy applications are typically intended for interactive use by the users/operators, and can employ a variety of record locking mechanisms of ensuring that changes are applied to data in an orderly manner. For example, some applications will first lock a record, then process any updates, and unlock the record only when the transaction is confirmed as completed. This is known as “pessimistic” record locking. In other implementations, an application may accept the entered data, check for additional updates to the same record and process the update if no other updates conflict. This is known as “optimistic” record locking. The work flow of the application may also alter the way changes to data are processed and applied. For example, a record may only be locked when the operator selects an option to maintain a record, or a record may be locked while the operator performs several steps in a particular process.

When an application is being used in an interactive session, a “state” of the application may be used to describe the status of the application and its connection to the underlying data supporting the transactions. For example, during an interactive session, the application is aware of who the operator is and the current context of the work the operator is performing. The context of the operator's session may vary depending of the actions being performed. For example, the operator may be working with a specific customer record. The business logic within the application may determine if the operator has exclusive access to the customer record for the duration of a process (a series of actions), for the duration of a single action, or if the data is shared. For some legacy applications, this state is essential to ensuring the integrity of the data it is responsible for managing.

Legacy applications are typically monolithic, i.e., they are responsible for all aspects of presentation, business processes and data access. Exposing business logic and data from legacy applications to the users as services can present a challenge when applying updates or changes to data that supports multiple independent systems of record. Specifically, services that expose business logic and data owned by the legacy application to other applications in the enterprise are typically designed to be “stateless” and “abstract.” A service is considered to be “stateless” when there is no session that manages the application state outside the invocation of the service, and “abstract” when the user or consumer of the service has no knowledge of how the service is implemented or which applications it interacts with. While it is possible to create fully state-aware, they are not the preferred choice because they require more resources and may limit throughput (the number of transactions that can be executed within a specific time period using resources available), whereas state-less services can make use of resource pooling to increase throughput (essential when considering customer self service).

Additionally, the shift to exposing services to provide access to legacy applications enables the designers of new user interfaces to present the operator with data relevant to their task gathered from many different sources in a manner that mirrors a business process work flow. In such cases, a process such as a two-phase commit is therefore required to ensure data integrity as changes are applied to the data across multiple applications and systems of record.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

FIG. 1 depicts an example a scope of a context.

FIG. 2 depicts an example of a system diagram to support enterprise-level context management.

FIG. 3 depicts an example a system diagram to further depict the integration component of the system.

FIG. 4 depicts an example of a flowchart of a process to support enterprise-level context management.

FIG. 5 depicts an example of a work flow of a customer service call and highlights the application context pertaining to the customer.

FIG. 6 depicts an example of a J2EE application utilized to control the work flow, which is presented to the operator via a Web browser.

FIG. 7 depicts an example where there are multiple applications in the enterprise that access the same legacy applications or resources.

FIG. 8 depicts an example of how a client application may interact with enterprise context manager 102 when controlling the work flow.

### DETAILED DESCRIPTION OF EMBODIMENTS

The techniques and systems described herein provide a new approach to facilitate enterprise-level context management. As used herein, “context management” is a construct used to manage access and changes to business entities at the enterprise level instead of application level, where the business entities are used by many legacy applications and the underlying data is stored across multiple systems of record. An enterprise context manager is used to enforce the construct, and is implemented as a software layer that secures exclusive access to a collection of related, yet disparate applications and resources ahead of a coordinated multiphase commit. The enterprise context manager provides a complete view of a business entity by presenting various aspects of data of the business entity through a single, unified user interface. It commits changes made to the data managed by two or more legacy applications together or rolls the data back to a pre-commit status if all changes cannot be applied. It is also able to handle changes to data managed by two or more legacy applications that do not share the same commit logic, e.g., one application may use pessimistic record locking while another uses optimistic record locking.

Many organizations operate multiple legacy application over multiple systems of record. In some cases, aspects of data representing a business entity (e.g. a customer) are owned by more than one system of record. Managing context at the enterprise level enables a coordinated multiphase commit across multiple systems of record of data that were never intended to participate in such an operation by multiple applications using existing standards for Web service transactions such as WS-Coordination, WS-AtomicTransaction, WS-BusinessActivity, etc.

As referred to hereinafter, the phrase “context” refers to the current state and scope of a user's interaction with a (legacy) application. It encapsulates who the user is, which business entity or entities they are working with, and which operations they wish to perform on that business entity during a work flow of a business process. As a non-limiting example, Joe is updating the address and telephone number of a customer. The application understands the context of Operator=“Joe”, Entity=“Customer”, Operation=“Update” and will either inform Joe he is not authorized to update the customer's address or will execute the operation and inform Joe the operation was successful. The application will ensure that Joe's change to the customer's address is committed successfully in such a way as to ensure the integrity of the database(s) that store the data. The customer's record may be locked until Joe finishes entering his changes (pessimistic lock), or perhaps the application may check if someone else had changed the customer's address before applying Joe's changes (optimistic lock).

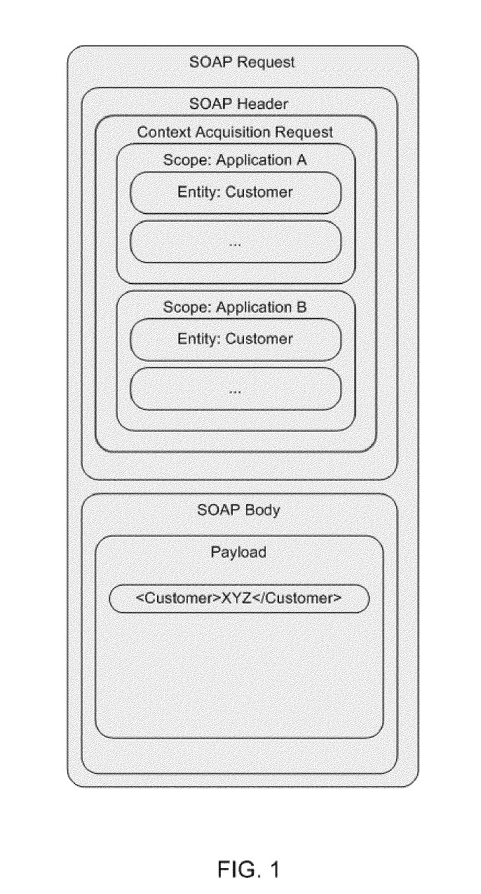

A context may have a scope, i.e., it may apply to all data elements of an entity or a subset of data elements. For example, as depicted in FIG. 1, an application may request the context: “Entity: Customer; Scope: Application A”, which implies that the user will be working with customer data in just one system of record. Alternatively, another application may request the context: “Entity: Customer; Scope: Application A; Scope: Application B”, meaning it will be using customer data that impacts two different systems of record. Yet another application may request the context: “Entity: Customer; Scope: *”, which suggests that it will be using customer data exclusively across *all* systems of record. In some embodiments, an enterprise context manager will not permit the application to acquire the context if a context already exists for the same entity with a matching, conflicting or overlapping scope.

The performance of tasks and business processes within an organization typically follows a “work flow” and may include use of and interaction with multiple applications. The “work flow” is closely tied with presentation, i.e. what the user sees on his/her terminal when interacting with the application. For example, Joe may take a call from a customer who wishes to place an order and in response Joe selects an option to “Enter new order.” The application leads Joe through collecting details such as identifying the customer, adding products and quantities to the order, selecting a delivery address, selecting a delivery method and accepting payment. In this example there are several entities (Customer, Order, Product) and several operations (Create Order, Calculate Shipping, Process Payment). The “context” describes the resources required to complete a work flow.

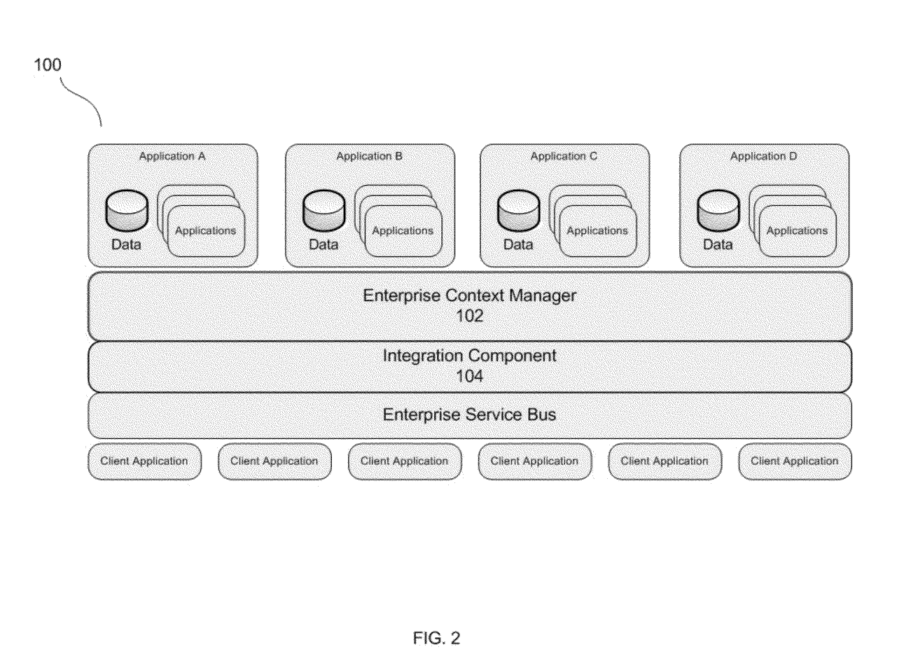

FIG. 2 depicts an exemplary system for implementing enterprise-level context management. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

The system 100 includes at least one enterprise context manager (enterprise context managing component) 102, integration component 104, and enterprise service bus 106. As used herein, the terms “manager” and “component” refers to software, firmware, hardware, or other components that are used to implement the functional elements of the modules described herein. They will typically include software instructions that are stored in non-volatile memory (also referred to as secondary memory). When the software instructions are executed, at least a subset of the software instructions are loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

Still referring to FIG. 2, each of the components can run on one or more hosting devices (hosts). Here, a host can be a computing device, a communication device, a storage device, or any electronic device capable of running a software component. For non-limiting examples, a computing device can be but is not limited to a laptop PC, a desktop PC, a tablet PC, wireless communication device such as a smartphone, or a PDA, or a server machine. A storage device can be but is not limited to a hard disk drive, a flash memory drive, or any portable storage device. A communication device can be but is not limited to a mobile phone.

Each of the components may have a communication interface (not shown), which is a software component that enables the components to communicate with each other following certain communication protocols, such as TCP/IP protocol, over one or more communication networks (not shown). Here, the communication networks can be but are not limited to, internet, intranet, wide area network (WAN), local area network (LAN), wireless network, cellular (e.g., 3G, 4G) Bluetooth, WiFi, and mobile communication network. The physical connections of the network and the communication protocols are well known to those of skill in the art.

Referring again to FIG. 2, enterprise context manager (ECM) 102 secures the context in which a work flow commits changes to data used during the work flow that is stored on multiple systems of record (e.g., Applications A, B, C, and D). It provides secure access to protected resources for the duration of long running, possibly interactive, business processes. In some embodiments, enterprise context manager 102 participates in a Service Oriented Architecture (SOA) in the context of business processes that utilizes data associated with the business entities managed by the legacy applications.

In some embodiments, enterprise context manager 102 provides an abstract interface to existing, standalone applications for the purposes of resource management. By presenting a common interface for acquiring secure access to protected resources, enterprise context manager 102 enables standards based, multiphase commit operations over systems that would otherwise be unable to participate in such operations.

In some embodiments, enterprise context manager 102 acts as a default resource manager for the existing, standalone applications that were not designed to consider the concept of resource management across multiple applications. In the case where a system of record secures access to data prior to an update (i.e., a resource manager), enterprise context manager 102 makes use of it. In the case where a system of record does not provide such a mechanism, enterprise context manager 102 acts as a virtual lock server. Conventional, proprietary application-specific virtual lock managers typically serve only a single application and do not necessary interface with resource managers of target systems, thus the burden of maintaining the resources falls on the organization's IT staff. In contrast, the enterprise context manager 102 serves as a virtual lock manager and a resource manager over multiple legacy applications at the same time and does so without creating additional overhead for the IT staff.

In some embodiments, enterprise context manager 102 enables transactional services among many legacy applications which do not support transactional resources and applications. Note that enterprise context manager 102 may be used in conjunction with a conventional transaction manager. Unlike a transaction manager such as IBM Resource Recovery Services (RRS) that enables transactions to update and synchronize protected resources managed by multiple resource managers on z/OS, enterprise context manager 102 works with various kinds of legacy applications not limited to those on z/OS applications that already support the concept of transactional updates. In that regard, the context manager 102 is agnostic as to the operating system or platform of the application it is accessing.

In some embodiments, enterprise context manager 102 applies existing standards for implementing Web services as transactions to expose business logic and data from legacy applications to the users. These standards include but are not limited to:
WS-Coordination, which is an extensible framework for providing protocols that coordinate the actions of distributed applications;
WS-AtomicTransaction, which includes completion, volatile two-phase commit, and durable two-phase commit; and
WS-BusinessActivity, which includes business agreement with participant completion, and business agreement with coordinator completion.
   The purpose of these standards is to enable existing transaction processing, work flow, and other systems to hide their proprietary protocols and to operate in a heterogeneous environment. Enterprise context manager 102 provides the awareness of the context under which these transactions operate for state-less, concrete services built over legacy applications, which cannot participate in such an environment otherwise.

In some embodiments, enterprise context manager 102 provides an abstraction of context management over legacy applications. So in some cases, enterprise context manager 102 checks a dedicated data source for an existing context and issue a new context if it is available. In other cases, enterprise context manager 102 actually communicates with the backend application to acquire the context by placing an entry in an activity table of a legacy application.

In some embodiments, enterprise context manager 102 is used to implement an authorization mechanism which dictates those operations that are allowed to be performed on an entity within the work flow by an operator. As a non-limiting example, the operator may be permitted to retrieve data about an entity, but may not be permitted to update it.

In some embodiments, enterprise context manager 102 may attach metadata to a context for the duration of the work flow. For example, a routing code may be stored within the context and re-used by some or all of the services that participate in the work flow. The inclusion of the meta data would be invisible to the consumer of the application and the determination of the routing code would only need to be performed once for each instance of a work flow. In some embodiments, the routing code may indicate to which instance of the legacy application a concrete service should be directed.

In some embodiments, instructions from enterprise context manager 102 forms part of the request meta data, and as an example may be carried in the SOAP header. Designers of abstract services that operate on top of legacy resources will specify the context that must be acquired to invoke the service i.e. Entity and Scope. It is quite possible that a service may require a context to include data for several different entities across several systems of record.

Again in the example of FIG. 2, integration point 104 is an abstraction layer that provides users with access to the legacy applications (e.g., Application A, B, C, and D) through a variety of protocols. It operates as a single point of entry for access to the legacy applications and the management of contexts for the associated legacy data.

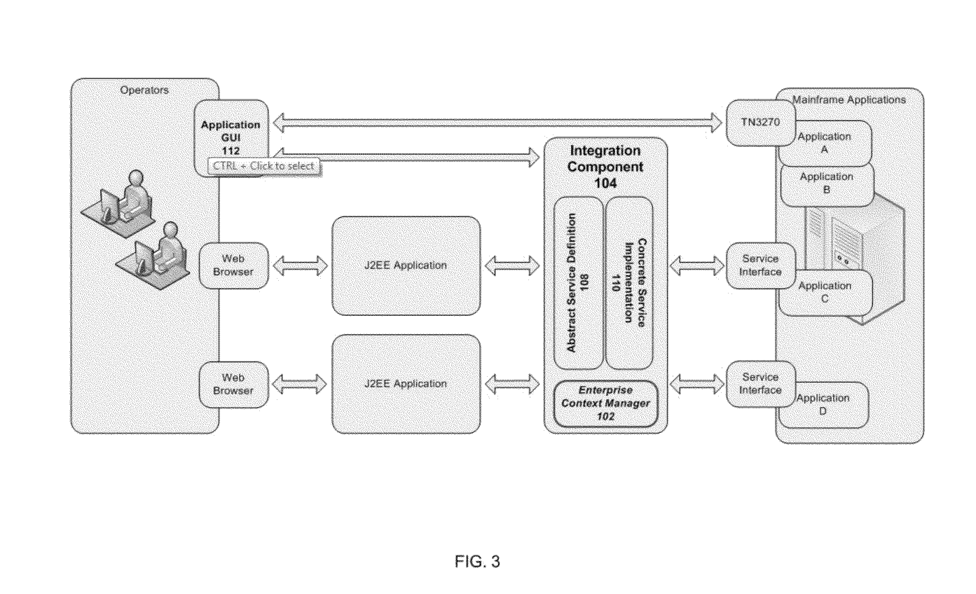

As illustrated in FIG. 3, integration component 104 provides abstract service definitions 108 and composite/concrete services implementation 110 to expose data and business logic of the legacy applications to the users and to coordinate various fine grained services. Such abstract service definitions and concrete/composite services enable the enterprise context manager 102 to provide truly “black box” services that rely on those legacy applications and resources and to receive the full benefit of a service oriented architecture.

In the example of FIG. 3, integration point 104 provides both integration services and presentation services directly to the users/operators via application graphical user interface (GUI) 112. The application GUI 112 can be used to provide graphical user interfaces with work flow improvements over legacy applications (e.g., Application A, B, C, and D) using screen-based protocols such as TN3270 and TN5250. Application GUI 112 can be used as a tactical solution to migrate users from the command line based screen operation to a full featured rich client interface. As shown in FIG. 3, application GUI 112 participates directly in context management along with other applications (e.g., J2EE applications) in the enterprise.

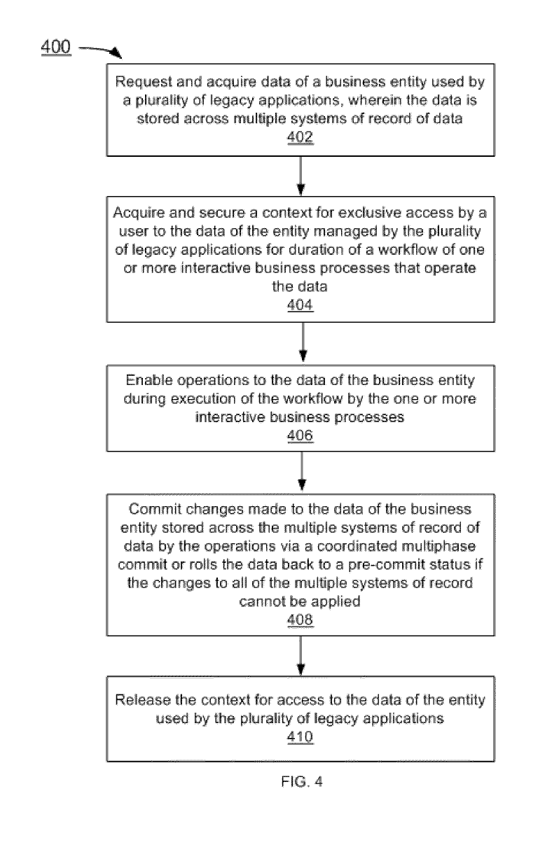

FIG. 4 is a flowchart illustrating a process 400 to implement and support enterprise-level context management. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 4, the process 400 starts with the request and acquisition of data used by and stored in a plurality of legacy applications (STEP 402). A context is then acquired and secured (STEP 404) that provides exclusive access by a user to the data of the entity managed by the plurality of legacy applications for duration of a work flow of one or more interactive business processes that use the data. Operations to the data are effected (STEP 406) by executing the interactive business processes during execution of the work flow. Any changes to the data are then made (STEP 408) across the multiple systems of record by the operations is committed via a coordinated multiphase commit or, if the changes cannot be applied, rolled back to a pre-commit status. The context is then released (STEP 410) allowing other services to access to the data.

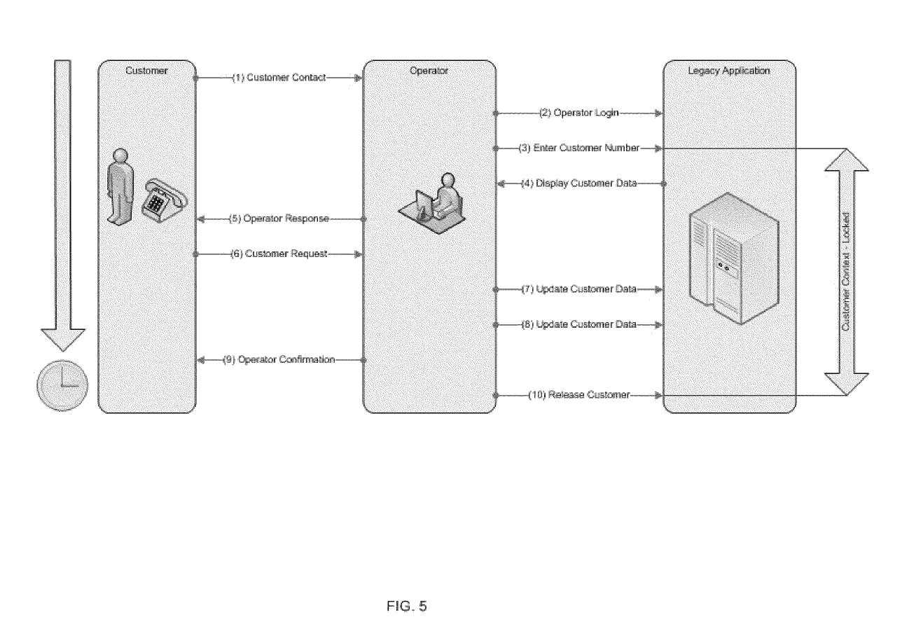

FIG. 5 illustrates an exemplary work flow for a customer service call and highlights the application context pertaining to the customer. The customer contacts a customer service representative (CSR) or operator via telephone to request a change of address (1). The CSR logs in and accesses the application (2), and using a customer number or other key locates the customer's record (3). The information is presented to the CSR (4), checks the current address and prepares to change it. The application then applies a lock to the customer's record. The CSR requests the new data from the customer (5) who provides the address and mentions that the telephone number has also changed (6). The CSR updates the customer's address and telephone number (7) and (8), instructs the application to store the change permanently and confirms to the customer that the change has been made (9). The application stores the change and releases the lock on the customer record (10). In this example, the work flow update by the customer requires exclusive access to the customer data entity. At the start of the work flow, the application issued a lock and only released it when the work flow had been completed. The application would have also verified that the CSR was authorized to make changes to customer data.

In the example of FIG. 5, the scope of the “customer context” is shown on the right hand side. i.e. the points in the work flow between which the CSR required exclusive access to the customer's data. During the existence of the context the CSR performed several operations against the customer's data. For example, the data was retrieved and several elements were altered.

Within a Service Oriented Architecture (SOA) presentation, business processes and data access are spread over several tiers and many different loosely coupled applications. When exposing services over legacy applications the legacy application is no longer responsible for presentation to the user or for work flow steps that the user will follow when participating in a business process. However, the legacy application is still responsible for any business rules, data access and data integrity. This also means that the legacy application maintains a context for the operations performed by the service implementation. With presentation and work flow being managed in a tier closer to the user, the implementation of a stateless service over the legacy application may break the link between the context and the work flow.

Referring to the example in FIG. 5 of a customer contacting a CSR to update their address and telephone number, the operations “retrieve customer data”, “update customer address” and “update customer telephone number” under SOA are now stateless services implemented over the legacy application. Because they are stateless, each service implementation will cause the customer record to be locked and released on each invocation. However, the business process for updating customer data still requires that the CSR have exclusive access to the customer's data for the duration of the work flow.

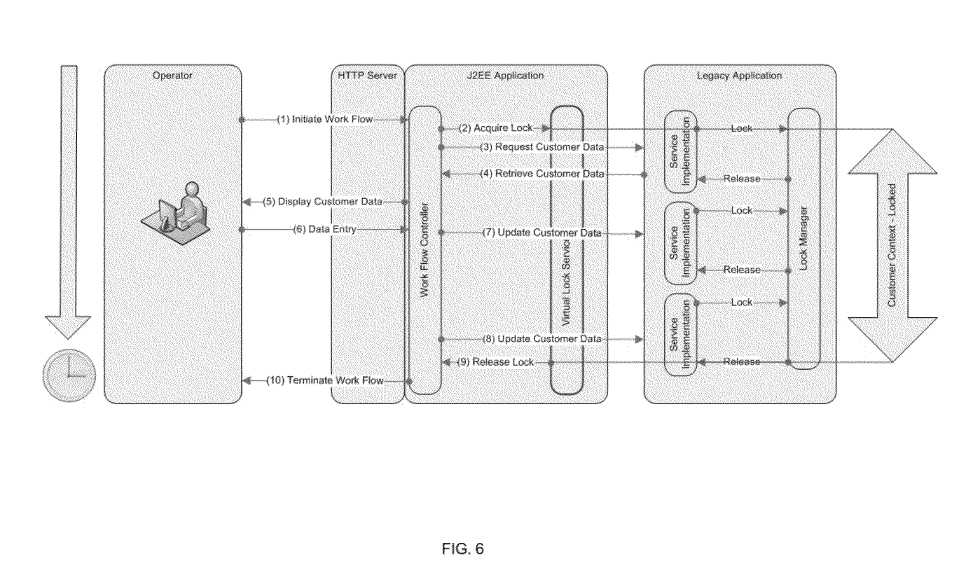

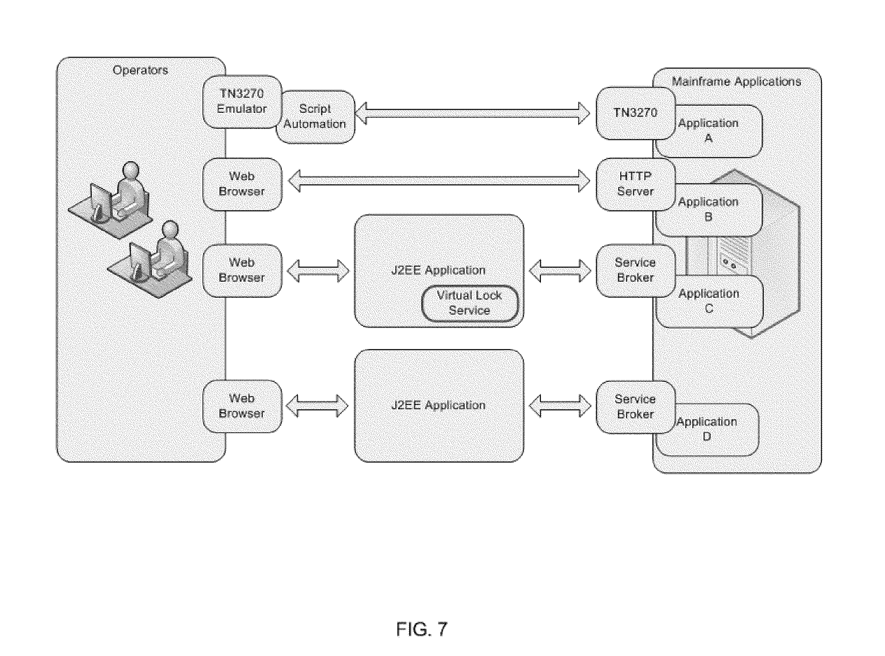

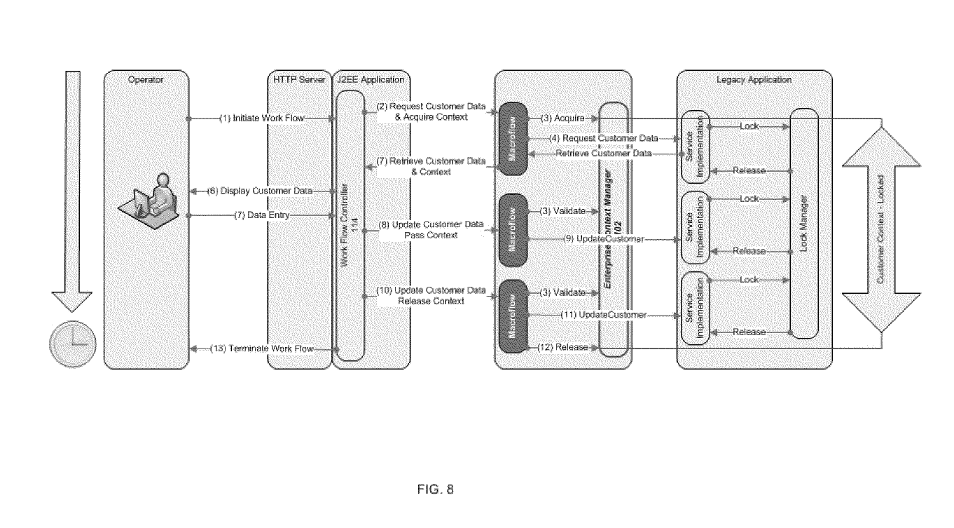

In one solution as depicted in FIG. 6, a J2EE application is utilized to control the work flow, which is presented to the operator via a Web browser. However, the work flow is the same as in the example of FIG. 5 above. A virtual lock server, running within the scope of the J2EE application server, maintains a record of context by customer. Users of this application may not work with a customer while an operator is engaged in a work flow for the customer. This has solved the problem of consuming stateless services that lock the customer record for the duration of the function performed for the user of this specific application.

Where there are other applications in the enterprise that access the same legacy applications or resources as shown in FIG. 7, the context by customer may not be respected. For multiple applications to share the same context, where data for an entity spans multiple systems of record, the context (by which to secure access to this data) must be managed at the enterprise level by the enterprise context manager 102 as depicted in FIG. 8.

FIG. 8 shows an example of how a client application might interact with enterprise context manager 102 using the proposed systems and methods as depicted in FIGS. 1, 2, and 4 when controlling the work flow used in the example discussed above. The work flow controller 114 invokes a service that retrieves customer information, while at the same time registers an intent to change this data with enterprise context manager 102. This is effectively a “read for update” operation. The customer data is retrieved and returned, along with a key representing the context by customer. The work flow controller 114 passes the context key in all subsequent service requests invoked by the work flow. In some embodiments, specific services may require a specific context. Each service will validate that the context key is valid and the context covers the scope required by the operation to be performed. The final service invoked by the work flow controller contains an instruction to release the context.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to facilitate enterprise-level context management, comprising:
an enterprise context manager, which in operation,
requests and acquires data of a business entity used by a plurality of legacy applications, wherein the data is stored across multiple systems of record of data;
acquires and secures a context for exclusive access by a user to the data of the entity managed by the plurality of legacy applications for duration of a work flow of one or more interactive business processes that operate the data;
enables operations to the data of the business entity during execution of the work flow by the one or more interactive business processes;
commits changes made to the data of the business entity stored across the multiple systems of record of data by the operations via a coordinated multiphase commit or rolls the data back to a pre-commit status if the changes to all of the multiple systems of record cannot be applied; and
releases the context for access to the data of the entity used by the plurality of legacy applications.

2. The system of claim 1, further comprising:
an integration component, which in operation, provides the user with access to the legacy applications under a plurality of protocols.

3. The system of claim 2, wherein:
the integration component provides abstract service definitions and concrete services implementation, thereby exposing the data elements and business logic of the legacy applications to the user.

4. The system of claim 1, further comprising:
an application graphical user interface (GUI) for presenting aspects of the business entity of data and the work flow through a single, unified user interface via screen-based protocols.

5. The system of claim 1, wherein:
the context has a scope that applies to at least a subset of data elements of the business entity.

6. The system of claim 5, wherein:
the enterprise context manager does not permit the context to be acquired if another context having a matching scope already exists for the same entity.

7. The system of claim 1, wherein:
the enterprise context manager attaches metadata to the context for the duration of the work flow.

8. The system of claim 1, wherein:
the enterprise context manager implements changes made to the data managed by two or more of the legacy applications, each having different commit logic.

9. The system of claim 1, wherein:
the enterprise context manager participates in a Service Oriented Architecture (SOA) in the context of the one or more business processes that utilize the data.

10. The system of claim 1, wherein:
the enterprise context manager provides an abstract interface for securing the context for exclusive access to the data elements, thereby enabling multiphase commit operations.

11. The system of claim 1, wherein:
the enterprise context manager acts as a virtual lock server for all of the plurality of applications at the same time.

12. The system of claim 1, wherein:
the enterprise context manager enables transactional services within the plurality of legacy applications that do not support transactional updates.

13. The system of claim 1, wherein:
the enterprise context manager applies existing standards for implementing Web service as transactions to expose business logic and data from the plurality of applications.

14. The system of claim 13, wherein:
the enterprise context manager provides awareness of the context under which the transactions operate for state-less, concrete services built over the plurality of applications.

15. The system of claim 1, wherein:
the enterprise context manager provides an authorization mechanism which define those operations that are allowed to be performed on the data within the work flow.

16. A method to facilitate enterprise-level context management, comprising:
requesting and acquiring data of a business entity used by a plurality of legacy applications, wherein the data is stored across multiple systems of record of data;
acquiring and securing a context for exclusive access by a user to the data of the entity managed by the plurality of legacy applications for duration of a work flow of one or more interactive business processes that operate the data;
enabling operations to the data of the business entity during execution of the work flow by the one or more interactive business processes;
committing changes made to the data of the business entity stored across the multiple systems of record of data by the operations via a coordinated multiphase commit or rolls the data back to a pre-commit status if the changes to all of the multiple systems of record cannot be applied; and
releasing the context for access to the data of the entity used by the plurality of legacy applications.

17. The method of claim 16, further comprising:
providing abstract service definitions and concrete services implementation, thereby exposing the data elements and business logic of the legacy applications to the user.

18. The method of claim 16, further comprising:
presenting aspects of the business entity of data and the work flow through a single, unified user interface via screen-based protocols.

19. The method of claim 16, further comprising:
not permitting the context to be acquired if another context having a matching scope already exists for the same entity, wherein the scope of the context applies to at least a subset of data elements of the business entity.

20. The method of claim 16, further comprising:
attaching metadata to the context for the duration of the work flow.

21. The method of claim 16, further comprising:
implementing the changes made to the data managed by two or more of the legacy applications, each having different commit logic.

22. The method of claim 16, further comprising:
participating in a Service Oriented Architecture (SOA) in the context of the one or more business processes that utilize the data.

23. The method of claim 16, further comprising:
providing an abstract interface for securing the context for exclusive access to the data elements, thereby enabling multiphase commit operations.

24. The method of claim 16, further comprising:
providing a virtual lock server for all of the plurality of applications at the same time.

25. The method of claim 16, further comprising:
enabling transactional services within the plurality of legacy applications that do not support transactional updates.

26. The method of claim 16, further comprising:
applying existing standards for implementing Web service as transactions to expose business logic and data from the plurality of applications.

27. The method of claim 26, further comprising:
providing awareness of the context under which the transactions operate for state-less, concrete services built over the plurality of applications.

28. The method of claim 16, further comprising:
providing an authorization mechanism which define those operations that are allowed to be performed on the data within the work flow.

29. A machine readable medium having software instructions stored thereon that when executed cause a system to:
request and acquire data of a business entity used by a plurality of legacy applications, wherein the data is stored across multiple systems of record of data;
acquire and secure a context for exclusive access by a user to the data of the entity managed by the plurality of legacy applications for duration of a work flow of one or more interactive business processes that operate the data;
enable operations to the data of the business entity during execution of the work flow by the one or more interactive business processes;
commit changes made to the data of the business entity stored across the multiple systems of record of data by the operations via a coordinated multiphase commit or rolls the data back to a pre-commit status if the changes to all of the multiple systems of record cannot be applied; and
release the context for access to the data of the entity used by the plurality of legacy applications.
